(19) United States
(12) Patent Application Publication
(10) Pub. No.: US 2009/0239098 A1
(43) Pub. Date: Sep. 24, 2009

(54) MAGNETIC HEAD AND METHOD FOR PRODUCING THE SAME

(75) Inventor: Tsutomu Komuro, Kawasaki (JP)

Correspondence Address: Fujitsu Patent Center;C/O CPA Global, P.O. Box 52050, Minneapolis, MN, 55402, US

(73) Assignee: FUJITSU LIMITED, Kawasaki (JP)

(21) Appl. No.: 12/408,713

(22) Filed: Mar. 22, 2009

(30) Foreign Application Priority Data
Mar. 24, 2008 (JP) 2008-075602

(51) Int. Cl. G11B 5/33

(52) U.S. Cl. 428/810; 216/22

(57) ABSTRACT

According to an aspect of an embodiment, a method for producing a magnetic head includes forming a plating base layer on a substrate; forming a magnetic layer including an enlarged portion and a narrowed portion extending therefrom on the plating base layer by plating; forming a resist pattern on the magnetic layer and the plating base layer, the resist pattern corresponding to the shape of the magnetic layer and entirely covering the magnetic layer with a margin such that the margin around the narrowed portion is larger than that around the enlarged portion; and patterning the plating base layer by etching with the resist pattern used as a mask. The method further includes forming an insulating layer over the magnetic layer and the plating base layer; and forming an auxiliary magnetic layer on the insulating layer so that the auxiliary magnetic layer is magnetically connected to the magnetic layer.

### CROSS REFERENCE TO RELATED APPLICATIONS

This application is based upon and claims the benefit of priority from the prior Japanese Patent Application No. 2008-075602 filed on Mar. 24, 2008, the entire content of which is incorporated herein by reference.

### BACKGROUND

1. Field

This art relates to methods for producing magnetic heads capable of writing information on storage media and, particularly, to a method for producing a magnetic head having a recording magnetic pole including a narrowed portion facing a storage medium for increased recording densities of storage media, and also to such a magnetic head.

2. Description of the Related Art

There is a growing demand for increased amounts of information that can be recorded on magnetic disk apparatuses (that is, increased recording densities). To meet that demand, some recording magnetic heads are proposed which have a main magnetic pole whose width (the width corresponding to a track-width direction of a storage medium; hereinafter referred to as the main magnetic pole width) on the storage medium side (that is, on the floating surface side) gradually decreases toward the storage medium (see, for example, Japanese Laid-open Patent Publications No. 60-101707 and No. 05-81614). According to an example of a method for forming such a main magnetic pole, a mask with a predetermined pattern is formed on a plating base layer before an unmasked region is plated to form a main magnetic pole. The plating is typically followed by removing the mask and processing the plating base layer into a shape corresponding to the outline of the main magnetic pole. One reason for such processing is that it prevents the plating base layer from being short-circuited through contact with another conductive member, such as a terminal, at some site apart from the main magnetic pole. Another reason is that the plating base layer, being a member necessary to form the main magnetic pole, remains as foreign matter in a finished magnetic head and may cause a malfunction in the recording and playback of a magnetic disk apparatus.

In the step of processing the plating base layer, first, a resist pattern is provided on the plating base layer and the main magnetic pole layer so that the plating base layer can be processed to a width corresponding to the main magnetic pole width, that is, a width slightly larger than the main magnetic pole width. The plating base layer is then processed into a shape corresponding to the resist pattern by physical etching such as ion milling. During the processing, the material forming the plating base layer is deposited beside the resist pattern. The deposit remains after the removal of the resist pattern, protruding along the pattern of the plating base layer. When such protrusions are further covered with other layers such as an insulating layer and an auxiliary magnetic pole layer in the subsequent process, they may cause problems, including failure to form the layers in desired shapes, defects or voids in the layers, and deviations from their desired compositions. Such problems may decrease the yield of magnetic heads. In a step of lapping or polishing the floating surface side, additionally, voids and low-density sites in the above layers will trap cuttings from the floating surface side, slurry, and platen material. The trapped cuttings and the materials forming portions with the above problems tend to come off inside the magnetic disk apparatus, thus leaving contaminants. Such contaminants may cause a serious malfunction in the recording and playback of information.

### SUMMARY

According to an aspect of an embodiment, a method for producing a magnetic head includes forming a plating base layer on a substrate; forming a magnetic layer including an enlarged portion and a narrowed portion extending therefrom on the plating base layer by plating; forming a resist pattern on the magnetic layer and the plating base layer, the resist pattern corresponding to the shape of the magnetic layer and entirely covering the magnetic layer with a margin such that the margin around the narrowed portion is larger than that around the enlarged portion; patterning the plating base layer by etching with the resist pattern used as a mask; forming an insulating layer over the magnetic layer and the plating base layer; and forming an auxiliary magnetic layer on the insulating layer so that the auxiliary magnetic layer is magnetically connected to the magnetic layer.

### BRIEF DESCRIPTION OF THE DRAWINGS

FIG. 1 is a plan view schematically illustrating a magnetic disk apparatus including a magnetic head.

FIG. 2 is a sectional view schematically illustrating a magnetic head serving as an embodiment of the magnetic head.

FIGS. 3A and 3B are sectional views schematically illustrating the magnetic head serving as an embodiment of the magnetic head.

FIG. 4 is a sectional view schematically illustrating the magnetic head serving as an embodiment of the magnetic head.

FIG. 5 is a schematic sectional view illustrating another embodiment of the magnetic head.

FIG. 6 is a schematic sectional view illustrating another embodiment of the magnetic head.

FIG. 7 is a schematic sectional view illustrating another embodiment of the magnetic head.

FIGS. 8A to 8G are schematic sectional views illustrating a first embodiment of a method for producing the magnetic head.

FIGS. 9A to 9D are schematic sectional views illustrating the first embodiment of the method for producing the magnetic head.

FIGS. 10A to 10F are schematic sectional views illustrating a method for forming a ferromagnetic layer in the first embodiment of the method for producing the magnetic head.

FIG. 11 is a perspective view of the ferromagnetic layer formed in the first embodiment of the method for producing the magnetic head.

FIG. 12 is a perspective view illustrating a plate member before the patterning of a plating base layer and a stopper layer in the first embodiment of the method for producing the magnetic head.

FIG. 13 is a perspective view illustrating a plate member after the patterning of the plating base layer and the stopper layer in the first embodiment of the method for producing the magnetic head.

FIG. 14 is a perspective view illustrating a plate member before the patterning of a plating base layer and a stopper layer in a second embodiment of the method for producing the magnetic head

FIG. 15 is a perspective view illustrating a plate member after the patterning of the plating base layer and the stopper layer in the second embodiment of the method for producing the magnetic head.

FIG. 16 is a perspective view illustrating a plate member before the patterning of a plating base layer and a stopper layer in a production method of a comparative example.

FIG. 17 is a perspective view illustrating a plate member after the patterning of the plating base layer and the stopper layer in the production method of the comparative example.

FIG. 18 is a perspective view illustrating the plate member after the patterning of the plating base layer and the stopper layer in the production method of the comparative example.

### DESCRIPTION OF THE EMBODIMENTS

Embodiments will now be described with reference to the drawings.

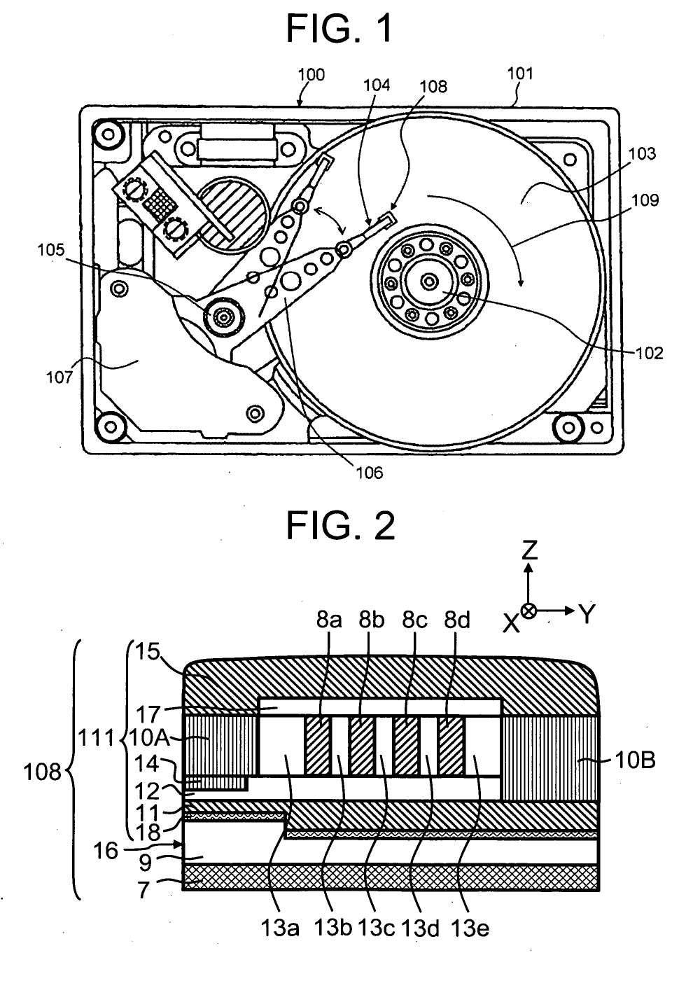

FIG. 1 is a plan view schematically illustrating a magnetic disk apparatus (hard disk drive: HDD) including a magnetic head. In the following description, like reference numerals indicate like components.

Referring to FIG. 1, an HDD 100 includes a housing 101. The housing 101 accommodates a storage medium (magnetic disk) 103 attached to a spindle motor 102 and a head gimbal assembly 104 facing the storage medium 103 with a magnetic head 108 mounted thereon. The magnetic head 108 functions to record or play back information on or from the storage medium 103. The magnetic head 108 includes a device section (not shown) for recording or playing back information on or from the storage medium 103 and a slider (not shown) facing the storage medium 103 with the device section disposed thereon. The head gimbal assembly 104, on which the magnetic head 108 is mounted, is fixed to a leading end of a carriage arm 106 that can be swung around a shaft 105.

In operation, the magnetic disk 103 rotates in the direction indicated by the arrow 109 while an actuator 107 swings the carriage arm 106 to position the magnetic head 108 at a target recording track on the magnetic disk 103. These operations allow the magnetic head 108 to write or read information on or from the storage medium 103.

Magnetic Head

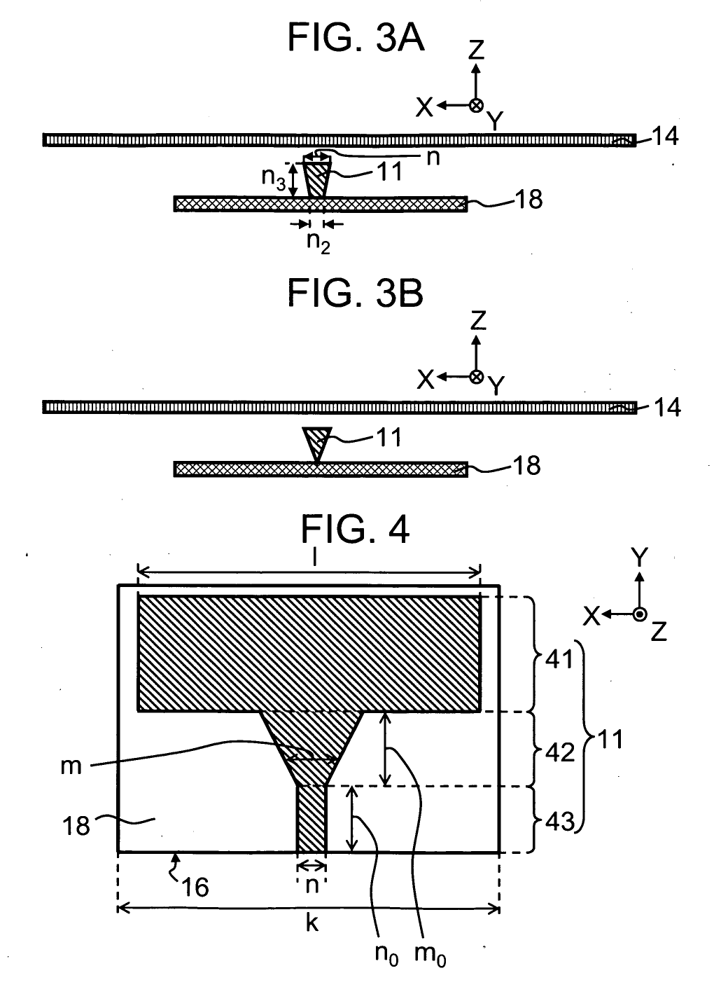

FIGS. 2 to 4 are sectional views schematically illustrating a magnetic head serving as an embodiment of the magnetic head. The magnetic head illustrated herein has a recording head section including a monopolar perpendicular magnetic head device. FIG. 2 is a schematic sectional view taken along a plane perpendicular to a surface opposite a storage medium (floating surface) and the diameter direction of the storage medium. FIGS. 3A and 3B are schematic plan views illustrating the floating surface. FIG. 4 is a schematic diagram illustrating a plane in which cross sections, parallel to a main surface of a substrate, of a main magnetic pole layer and a plating base layer are superimposed.

In the following description, the X-axis direction refers to the diameter direction of the storage medium, the Y-axis direction refers to a direction opposite to the storage medium, and the Z-axis direction refers to a direction in which layers are stacked on the substrate (hereinafter referred to as the “stacking direction with respect to the substrate”) or a direction in which the storage medium moves relative to the magnetic head. The X-axis, the Y-axis, and the Z-axis are perpendicular to each other. The dimensions in the X-axis, Y-axis, and Z-axis directions are referred to as the “width”, the “length”, and the “thickness”, respectively. The side of the magnetic head closer to the floating surface (air-bearing surface: ABS) in the Y-axis direction is referred to as the “floating surface side”, whereas the side farther away from the floating surface is referred to as the “height side”. These terms are similarly used in FIGS. 3A and 3B and the subsequent drawings.

The magnetic head of this embodiment is mounted as a magnetic recording device on a magnetic recording apparatus such as an HDD. This magnetic head includes a substrate 7 formed of a ceramic material such as AlTiC (Al₂O₃TiC) on which an insulating layer 9 formed of aluminum oxide (Al₂O₃, hereinafter simply referred to as “alumina”), a recording head section 111 capable of recording information at any position on a recording surface of the storage medium by perpendicular recording, and an overcoat layer (not shown) formed of a material such as alumina are stacked in the above order.

The insulating layer 9 is formed on the AlTiC substrate 7. The insulating layer 9 is formed of a nonmagnetic, nonconductive material such as alumina. The insulating layer 9 may have a heater (not shown) embedded therein. The heater heats the recording head section 111 so that it expands and protrudes toward the floating surface side. The heater used may be, for example, a resistance heater. The resistance heater is formed of, for example, titanium-tungsten (Ti—W) alloy, tungsten, or nickel-copper (Ni—Cu) alloy. Controlling the power supplied to the resistance heater allows it to generate heat, and, depending on the heat, the amount of protrusion of the recording head section 111 (particularly, a main magnetic pole layer 11, as described below) can be controlled. In a magnetic disk apparatus, the amount of protrusion can be controlled to set a suitable amount of floating for recording or playback.

The recording head section 111 includes, for example, the main magnetic pole layer 11, a plating base layer 18, a trailing shield layer 14, connecting layers 10A and 10B, coil layers 8a to 8d (hereinafter also collectively referred to as a coil 8), resin layers 13a to 13e (hereinafter also collectively referred to as a resist 13), a return yoke layer 15, and insulating layers 12 and 17.

The main magnetic pole layer 11, the connecting layer 10B, the return yoke layer 15, the connecting layer 10A, and the trailing shield layer 14 are formed of magnetic materials and are magnetically connected to each other. These magnetic members are magnetically and electrically insulated from the coil 8 by the insulating layers 12 and 17 and the resist 13. The surfaces of the coil 8, the resist 13, and the connecting layer 10A farther away from the substrate 7 are polished so that they are substantially flush with each other.

The coil layers 8a to 8d function primarily to generate a recording magnetic flux. The coil layers 8a to 8d are formed of a conductive material such as copper (Cu) and have a thickness of, for example, about 1 to 3 μm. Coil layers disposed on the height side of the connecting layer 10B are not shown.

The main magnetic pole layer 11 functions primarily to collect the magnetic flux generated by the coil layers 8a to 8d and to emit it toward the magnetic disk (not shown). The main magnetic pole layer 11 is typically exposed in a floating surface 16. The main magnetic pole layer 11 is formed of, for example, iron-cobalt (Fe—Co) alloy, iron-based alloy (Fe—M, where M is a metal element from Groups 4, 5, 6, 13, and 14), or a nitride thereof and has a thickness of about 0.1 to 0.5 μm. The main magnetic pole layer 11 is a specific example of a “magnetic layer” in the present invention.

The plating base layer 18 is a layer functioning as an electrode when the main magnetic pole layer 11 is formed by plating. The plating base layer 18 can be formed of any conductive material, such as tantalum (Ta), titanium (Ti), or ruthenium (Ru).

The trailing shield layer 14 functions primarily to steepen the gradient of the writing magnetic field emitted from the main magnetic pole layer 11 when it returns to the return yoke layer 15 via the hard disk (not shown). At the same time, the trailing shield layer 14 functions to magnetically insulate the main magnetic pole layer 11 from its surroundings. The trailing shield layer 14 is typically exposed in the floating surface 16. The trailing shield layer 14 is formed of a magnetic material such as nickel-iron alloy (Ni—Fe, hereinafter simply referred to as “permalloy” (trade name); nickel: 80% by weight; iron: 20% by weight) and has a thickness of about 1.0 to 2.0 μm. The trailing shield layer 14 is a specific example of an “auxiliary magnetic layer” in the present invention.

The return yoke layer 15 functions to allow the magnetic flux emitted from the main magnetic pole layer 11 to return to the recording head section 111 via the hard disk (not shown). The return yoke layer 15 is formed of a magnetic material such as permalloy (nickel: 80% by weight; iron: 20% by weight) and has a thickness of about 1.0 to 4.0 μm. The return yoke layer 15 is a specific example of an “auxiliary magnetic layer” in the present invention.

The resin layers 13a to 13e are formed of, for example, a photoresist (photosensitive resin) that displays fluidity when heated. The resin layers 13a to 13e may be replaced with a ceramic material such as alumina. The resin layers 13a to 13e are a specific example of an “insulating layer” in the present invention.

The insulating layer 12 is formed of a material that ensures electrical insulation between the coil 8 and the main magnetic pole layer 11 and that is also nonmagnetic. The insulating layer 12 is formed of, for example, a nonmagnetic, nonconductive material such as alumina or silicon oxide (SiO₂), although a nonmagnetic, conductive material such as ruthenium (Ru) or copper (Cu) may be used on its floating surface side. The thickness of the insulating layer 12 is about several tens to several hundreds of nanometers on the floating surface side and is about 0.1 to 1.0 μm on the height side. The insulating layer 12 may be formed of a plurality of materials or a plurality of layers of different materials. The insulating layer 12 is a specific example of an “insulating layer” in the present invention.

The insulating layer 17 is disposed over the coil 8 and the resist 13. The insulating layer 17 is formed of a nonmagnetic, nonconductive material such as alumina, silicon oxide (SiO₂), or a photoresist and has a thickness of, for example, about 0.1 to 1.0 μm. If the insulating layer 17 is formed of a photoresist, it is typically integrally formed with the resist 13. The insulating layer 17 is a specific example of an “insulating layer” in the present invention.

The connecting layer 10A is intended to magnetically connect the return yoke layer 15 and the trailing shield layer 14 together and is typically disposed on the floating surface side of the coil 8. The connecting layer 10B, on the other hand, is intended to magnetically connect the return yoke layer 15 and the main magnetic pole layer 11 together and is typically disposed on the height side of the coil 8. The connecting layers 10A and 10B are typically formed of a magnetic material such as permalloy (nickel: 80% by weight; iron: 20% by weight). The connecting layer 10A is a specific example of an “auxiliary magnetic layer” in the present invention.

The connecting layer 10B is intended to magnetically connect the main magnetic pole layer 11 to the trailing shield layer 14, the connecting layer 10A, and the return yoke layer 15 (that is, “auxiliary magnetic layers” in the present invention) and is typically disposed on the height side of the coil 8. The connecting layer 10B is formed of a magnetic material such as permalloy (nickel: 80% by weight; iron: 20% by weight).

The overcoat layer (not shown) is disposed on the top surface of the recording head section 111 to protect the recording head section 111. The material of the overcoat layer is not particularly limited and may be, for example, alumina.

The magnetic head can be produced by forming the above layers on the ceramic substrate 7 in order from bottom to top in FIG. 2 using known thin-film processes, including film-formation techniques such as plating and sputtering, patterning techniques such as photolithography and etching, and polishing techniques such as machining and polishing. A method for producing such a magnetic head will be described in more detail later.

To record information on a recording layer of the storage medium with the magnetic head 108 of FIG. 2 positioned thereover, a current is supplied to the coil 8 near the main magnetic pole layer 11 to generate a predetermined magnetic flux. The magnetic flux generated by the coil 8 passes through the main magnetic pole layer 11 and flows out of the floating surface 16 toward the surface of the storage medium (not shown). The magnetic flux flows into the recording layer and then flows out of the recording layer into the trailing shield layer 14, the connecting layer 10A, and the return yoke layer 15. A magnetic circuit is thus constituted by the main magnetic pole layer 11, the storage medium (not shown), the trailing shield layer 14, the connecting layer 10A, the return yoke layer 15, and the connecting layer 10B. This magnetic circuit can be used to record magnetism (information) on the recording layer perpendicularly to the surface of the storage medium.

Referring to FIG. 3A, the main magnetic pole layer 11 has an inverted trapezoidal cross-sectional shape on the floating surface side. In recording operation, the inverted trapezoidal cross-sectional shape prevents the main magnetic pole layer 11 from recording magnetic information on a wrong track because of a tilted angle (skew angle) of the magnetic head with respect to the circumferential direction (track direction) of the magnetic storage medium. The cross-sectional pattern of the main magnetic pole layer 11 on the floating surface side has, for example, a top width n of one hundred and several tens of nanometers, a bottom width n₂ of several tens of nanometers, and a thickness n₃ of two hundred and several tens of nanometers. Referring to FIG. 3B, alternatively, the main magnetic pole layer 11 may have an inverted triangular cross section on the floating surface side. In this case, the main magnetic pole layer 11 does not adhere to the plating base layer 18; the sides of the inverted triangle are filled with a nonmagnetic insulating material such as alumina (not shown).

Referring to FIG. 4, the main magnetic pole layer 11 includes a magnetic-field inducing portion 41, a flared portion 42, and a leading-end portion 43. The magnetic-field inducing portion 41 is a relatively enlarged portion where a magnetic field for recording is induced by the coil. The width I of the magnetic-field inducing portion 41 is not less than the width m of the flared portion 42. The width I of the magnetic-field inducing portion 41 is, for example, several tens of micrometers.

The flared portion 42 is a tapered portion that concentrates the magnetic flux induced in the magnetic-field inducing portion 41 and guides it to the leading-end portion 43. The width m of the flared portion 42 increases toward the magnetic-field inducing portion 41 and decreases toward the leading-end portion 43; it ranges from, for example, about 0.1 to 3.0 μm. The length mo of the flared portion 42 is, for example, 100 to 150 nm. The width m of the flared portion 42 is not less than the width n of the leading-end portion 43 and is not more than the width I of the magnetic-field inducing portion 41. The width n of the leading-end portion 43 is, for example, about several tens of nanometers to one hundred and several tens of nanometers.

The leading-end portion 43 is a portion for magnetic recording that emits the magnetic field from the floating surface 16 toward the magnetic storage medium. The length no of the leading-end portion 43 (generally called a throat height) is, for example, one hundred and several tens of nanometers.

The plating base layer 18 has a width k corresponding to the width I of the magnetic-field inducing portion 41, which is wider than the leading-end portion 43 in the main magnetic pole layer 11. The corresponding width k is, for example, about 0.1 to 0.5 μm larger than the width I; the difference between the widths I and k is a manufacturing margin. An unnecessarily large corresponding width k is not beneficial; it may pose, for example, the risk of the plating base layer 18 being electrically short-circuited to a conductive terminal (not shown) required for the operation of the magnetic head.

In this magnetic head, the plating base layer 18 is wider than the main magnetic pole layer 11 so as to correspond to the shape of the main magnetic pole layer 11 and has an accurate edge shape. The reason will now be described. The plating base layer 18 is typically formed through the following process. First, the plating base layer 18 is provided over the entire surface of the substrate 7 on which the insulating layer 9 is disposed. The main magnetic pole layer 11 is then provided in a desired shape as viewed in the direction toward the main surface of the substrate 7. The main magnetic pole layer 11 has a supporting segment (not shown) at the end of the leading-end portion 43 and the flared portion 42, which extend from the magnetic-field inducing portion 41, to maintain the shape of the leading-end portion 43 during the processing of the main magnetic pole layer 11. The supporting segment typically has a width larger than the width n of the leading-end portion 43. Subsequently, the plating base layer 18 is processed into a shape that is wider than the width I of the magnetic-field inducing portion 41 so as to correspond to the shape of the magnetic-field inducing portion 41 of the main magnetic pole layer 11. In this processing, first, a resist pattern wider than the width I of the magnetic-field inducing portion 41 is provided over the entire main magnetic pole layer 11 and part of the plating base layer 18. The resist pattern has such a shape that the plating base layer 18, which is wider than the main magnetic pole layer 11 so as to correspond to the shape of the main magnetic pole layer 11, can be formed. The plating base layer 18 is then etched by physical etching such as ion milling. To prevent the material forming the plating base layer 18, for example, from being redeposited in the periphery of the plating base layer 18 after being scattered by an incident ion beam, the ion beam is typically made incident at an angle of incidence larger than 0° with respect to the main surface of the substrate 7. During the irradiation with the ion beam, additionally, the substrate 7 is rotated about a certain axis perpendicular to its main surface. In such ion milling using the above resist pattern, the material forming the plating base layer 18, for example, is less likely to be redeposited in the periphery of the plating base layer 18 because the resist blocks the ion beam in its periphery only for a short period of time, so that no protrusions containing the material forming the plating base layer 18 are formed in the periphery of the plating base layer 18. That is, the plating base layer 18 has an accurate edge shape. Accordingly, the layers formed over the plating base layer 18, including the insulating layer 12, the trailing shield layer 14, and the return yoke layer 15, have desired shapes and compositions. Because the layers formed over the plating base layer 18 have desired shapes and compositions, they are less likely to come off inside a magnetic disk apparatus including the magnetic head of this embodiment. Thus, the magnetic disk apparatus including the magnetic head has high reliability. Matter coming off from a magnetic head would act as a contaminant inside a magnetic disk apparatus and cause a malfunction in the recording and playback of information.

The width k of the plating base layer 18 may correspond to a width smaller than the width I of the magnetic-field inducing portion 41 in parts of the plating base layer 18 that extend beside the narrowed portion (leading-end portion 43). For example, the width k of the plating base layer 18 may correspond to the width of the supporting segment, provided to maintain the shape of the leading-end portion 43, of the ferromagnetic layer to be processed into the main magnetic pole layer 11 in the parts of the plating base layer 18 that extend beside the narrowed portion. In other words, it is possible that the plating base layer 18 have a margin extending outwardly from the periphery of the magnetic layer, the margin around the leading-end portion 43 being larger than that the magnetic-field inducing portion 41. In the description of methods for producing magnetic heads, as described later, a magnetic head produced by a method illustrated in a second embodiment includes a main magnetic pole layer of such a shape, and its plating base layer has an accurate edge shape. That is, the plating base layer is formed through patterning by etching so that no protrusions containing the material forming the plating base layer are formed in the periphery of the plating base layer. The margin of the plating base layer 18 preferably has a straight edge so as to prevent deposition of the material of the plating base layer around the leading-end portion 43 which would otherwise occur during etching of the plating base layer. Accordingly, a magnetic disk apparatus including the magnetic head having the main magnetic pole layer of the above shape has high reliability for the same reason as the magnetic head illustrated with reference to FIGS. 2 to 4.

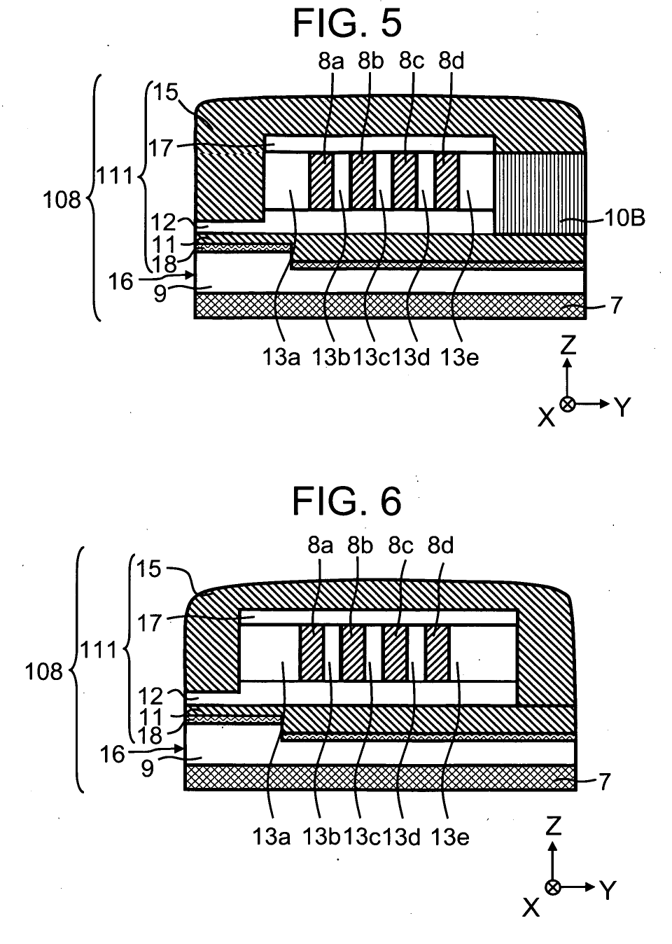

FIGS. 5 to 7 are schematic sectional views illustrating other embodiments of the magnetic head. In the magnetic heads shown in FIGS. 5 to 7, the cross-sectional shape of the floating surface side and the cross-sectional shapes of the main magnetic pole layer and the plating base layer parallel to the main surface of the substrate are similar to those shown in FIGS. 3A, 3B, and 4; a description thereof will be omitted. While the magnetic head of the embodiment described above includes the trailing shield layer 14 and the connecting layers 10A and 10B, for example, the trailing shield layer 14 and the connecting layer 10A may be omitted as in FIG. 5, or the trailing shield layer 14 and the connecting layers 10A and 10B may be omitted as in FIG. 6.

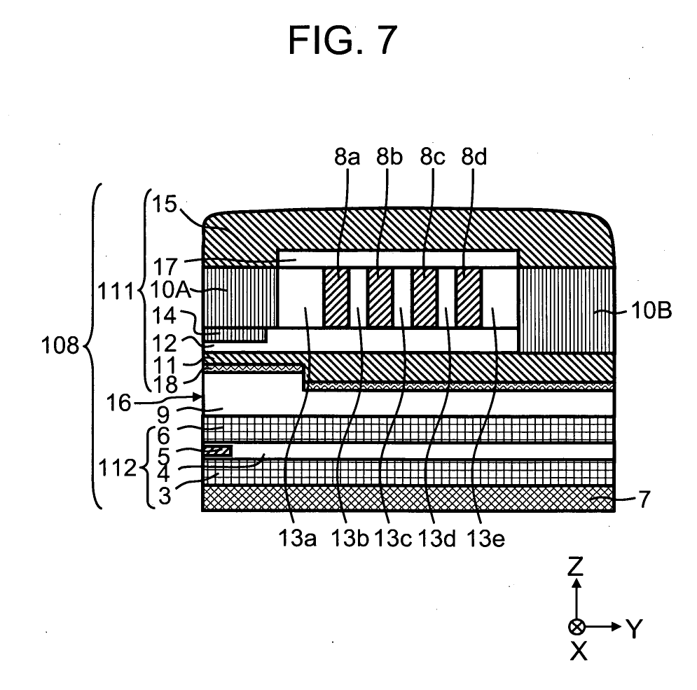

Alternatively, the magnetic head may be a composite head combining recording and playback functions. For example, a playback head section 112, the insulating layer 9, the recording head section 111, and the overcoat layer (not shown) may be stacked on the substrate 7 in the above order. Referring to FIG. 7, for example, the magnetic head may further include the playback head section 112. The playback head section 112 includes, for example, a lower shield layer 3, a gap film 4, and an upper shield layer 6 that are stacked in the above order. In the gap film 4, a magnetoresistive element (hereinafter abbreviated to an MR element) 5 is embedded as a magnetic playback device with its end surface exposed in the floating surface 16.

The lower shield layer 3 and the upper shield layer 6 function primarily to magnetically insulate the MR element 5 from its surroundings. The lower shield layer 3 and the upper shield layer 6 are formed of a magnetic material such as permalloy (nickel: 80% by weight; iron: 20% by weight) and have a thickness of about 1.0 to 2.0 μm.

The gap film 4 magnetically and electrically insulates the MR element 5 from the lower shield layer 3 and the upper shield layer 6. The gap film 4 is formed of a nonmagnetic, nonconductive material such as alumina and has a thickness of about 0.1 to 0.2 μm. The MR element 5 may be composed of a magnetosensitive film having a magnetoresistance effect such as the giant magnetoresistance (GMR) effect or the tunneling magnetoresistance (TMR) effect. In the magnetic heads shown in FIGS. 5 to 7, like the magnetic head shown in FIGS. 2 to 4, the plating base layer 18 has an accurate edge shape. Accordingly, magnetic disk apparatuses including these magnetic heads have high reliability.

Method for Producing Magnetic Head

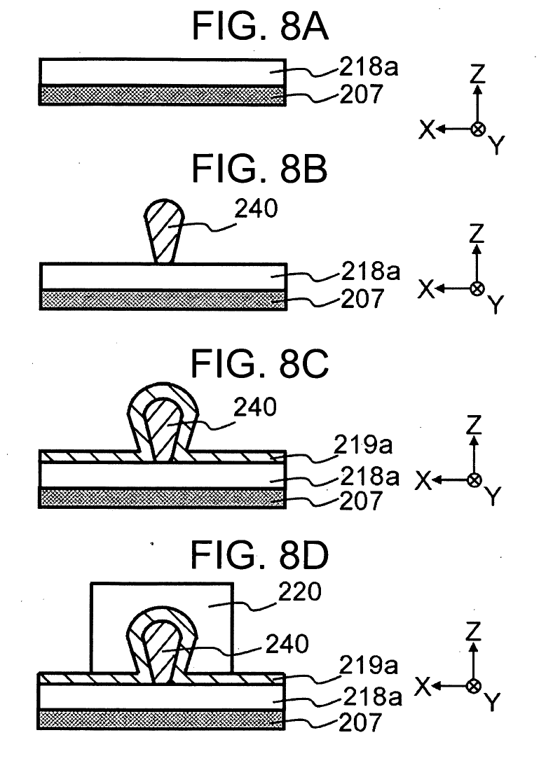

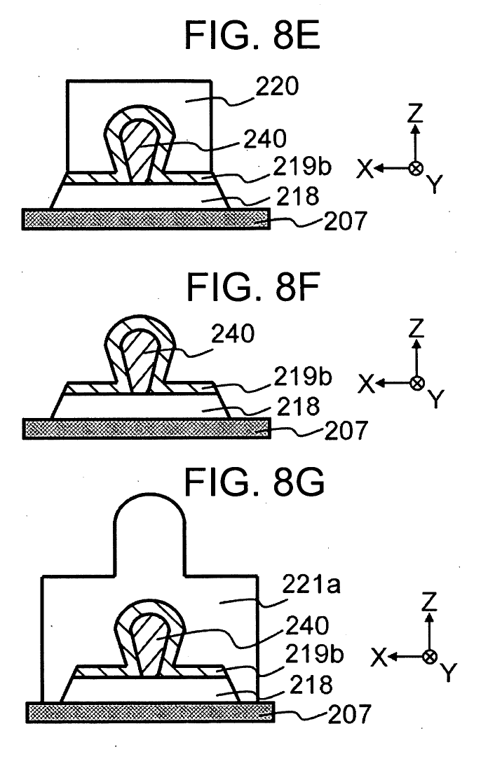

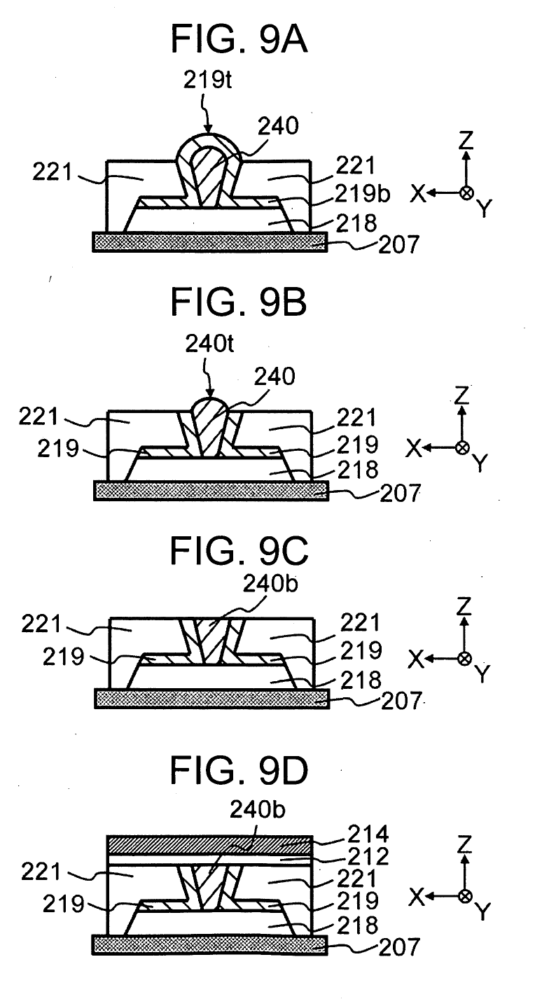

FIGS. 8A to 8G and 9A to 9D are schematic sectional views illustrating a first embodiment of a method for producing the magnetic head. These schematic sectional views show a plate member during the production of a magnetic head similar to that shown in FIGS. 2 to 4 in a cross section corresponding to the floating surface of the magnetic head to be eventually produced. In the following description, the details overlapping those described in the above embodiment will be skipped.

Referring to FIG. 8A, first, an insulating layer (not shown) of a material such as alumina is formed on a substrate 207 of a material such as AlTiC. A plating base layer 218a of a material such as ruthenium is then formed on the substrate 207 on which the insulating layer has been formed by, for example, sputtering. Referring to FIG. 8B, next, a ferromagnetic layer 240 is formed on the plating base layer 218a. The ferromagnetic layer 240 is to be processed into a main magnetic pole layer in the subsequent process, as described later. The ferromagnetic layer 240 is a specific example of a “magnetic layer” in the present invention.

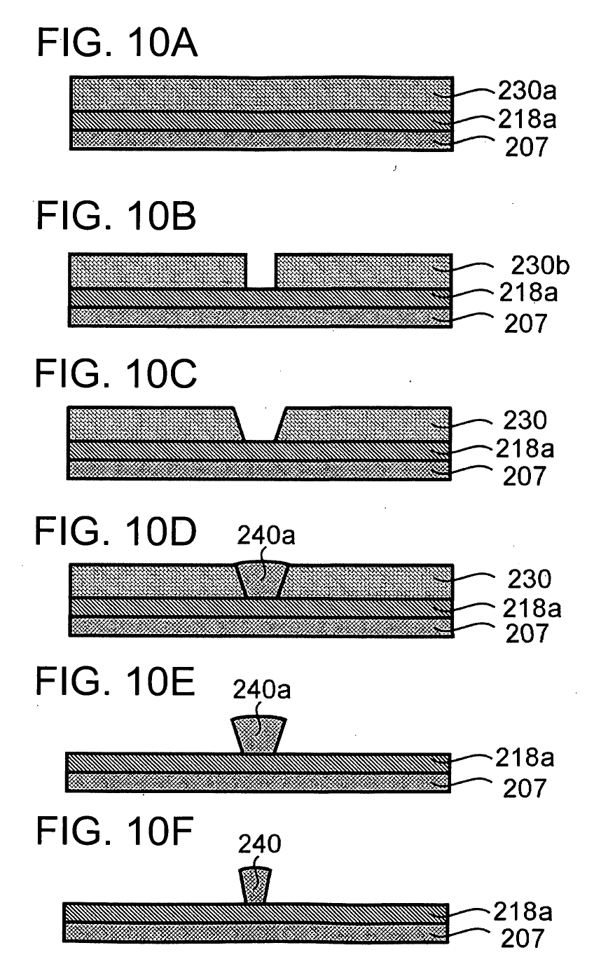

FIGS. 10A to 10F are schematic sectional views illustrating a method for forming a ferromagnetic layer. These schematic sectional views show a cross section of a leading-end portion of the ferromagnetic layer (that is, a cross section corresponding to the floating surface of the magnetic head to be produced).

Referring to FIG. 10A, first, a resist layer 230a is formed on the surface of the plating base layer 218a. The resist used may be either positive or negative. Referring to FIG. 10B, next, a resist pattern 230b is formed by a typical photolithography technique. Specifically, for example, the resist layer 230a is exposed with a photomask placed thereover before an exposed region of the resist layer 230a is removed by development. The mask is a perforated mask having an opening corresponding to the pattern of a main magnetic pole layer 211. The types of exposure equipment (exposure conditions) and developer used may be appropriately selected. After the development, the resist pattern 230b has edges substantially perpendicular to the substrate 207, as shown in FIG. 10B. The resist pattern 230b is then allowed to reflow (fluidize) in a heating furnace at a predetermined temperature, so that a tapered resist pattern 230 is formed, as shown in FIG. 10C.

Referring to FIG. 10D, next, the tapered resist pattern 230 is plated with a ferromagnetic material (for example, permalloy) to form a ferromagnetic layer 240a. After the resist pattern 230 is removed (FIG. 10E), the ferromagnetic layer 240a is slimmed by ion milling to form the ferromagnetic layer 240 (FIG. 10F). In FIG. 10F, the ferromagnetic layer 240 maintains its inverted trapezoidal shape, although it is formed in an inverted triangular shape, as described above, if the leading-end portion is narrower or the ion milling is continued longer. In the production flow shown in FIGS. 10A to 10F, the pattern thickness (that is, the plating thickness) is also reduced during the ion milling because ions etch not only the side surfaces of the pattern (ferromagnetic plating pattern), but also the top surface thereof.

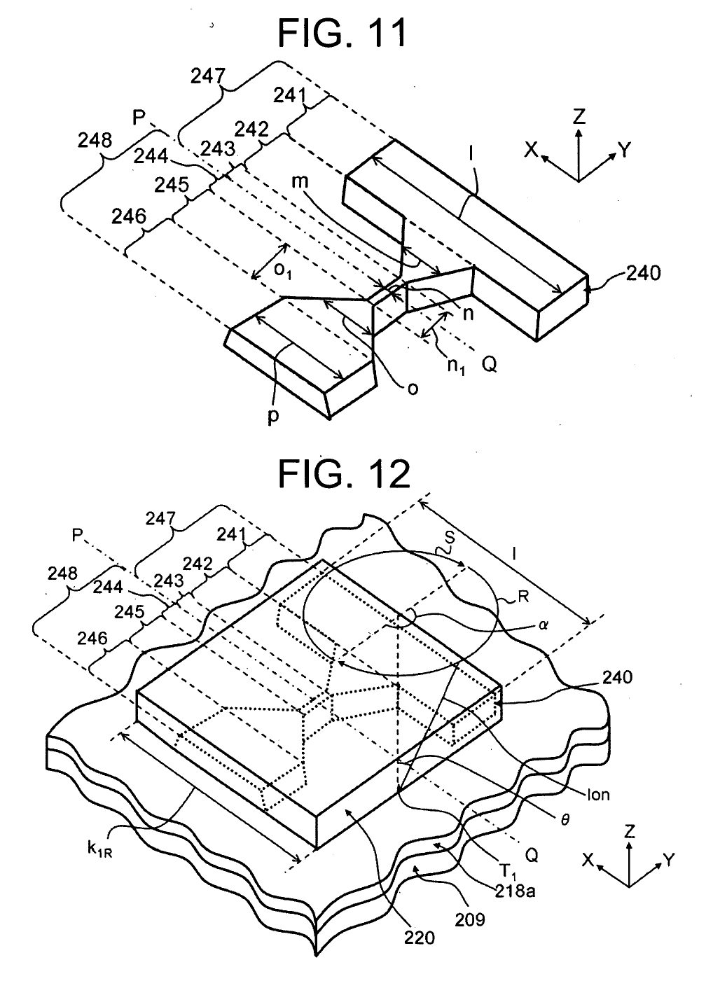

FIG. 11 is a perspective view of the ferromagnetic layer formed by the method described with reference to FIG. 10; it shows the pattern of the ferromagnetic layer formed on the plating base layer in the magnetic head that is yet to be finished during the production thereof. The ferromagnetic layer 240 includes a main magnetic pole segment 247 to be processed into the main magnetic pole layer 211 in the magnetic head and a supporting segment 248 formed integrally with the main magnetic pole segment 247 to maintain its shape during the production. The main magnetic pole segment 247 includes a magnetic-field inducing portion 241, a flared portion 242, and a leading-end portion 243. The main magnetic pole segment 247, the flared portion 242, and the leading-end portion 243 are magnetically connected together. The width I (dimension in the X-axis direction) of the magnetic-field inducing portion 241 in a cross section perpendicular to the stacking direction is not less than the width m of the flared portion 242. A magnetic field is induced in the magnetic-field inducing portion 241 by a coil (not shown). The flared portion 242 is adjacent to the magnetic-field inducing portion 241 and the leading-end portion 243. The flared portion 242 is tapered, with its width m decreasing from the magnetic-field inducing portion 241 toward the leading-end portion 243. The leading-end portion 243 is adjacent to the flared portion 242. The leading-end portion 243 typically has a substantially constant width n to define a constant magnetic pole width. The width n of the leading-end portion 243 is not more than the width m of the flared portion 242. The magnetic-field inducing portion 241 is an example of an “enlarged portion” in the present invention. The leading-end portion 243, on the other hand, is an example of a “narrowed portion” in the present invention. The supporting segment 248 is intended to prevent the leading-end portion 243, which is narrow and tall relative to its width, from falling or bending during the production of the magnetic head. The supporting segment 248 and the flared portion 242 are disposed with the leading-end portion 243 held therebetween. That is, the flared portion 242 and magnetic-field inducing portion 241 of the main magnetic pole segment 247 and the supporting segment 248 are formed in such a pattern that they support the leading-end portion 243 like a bridgehead. The supporting segment 248 may be formed in any shape serving the above purpose. As in this embodiment, for example, the supporting segment 248 may have a shape including a leading-end supporting portion 244 having substantially the same width n as the leading-end portion 243, a flared supporting portion 245 having a tapered shape, and a wide supporting portion 246. The width o of the flared supporting portion 245 is not less than the width n of the leading-end supporting portion 244 and is not more than the width p of the wide supporting portion 246.

The width I of the magnetic-field inducing portion 241 is, for example, about several tens of micrometers. The width m of the flared portion 242 is, for example, about 0.1 to 30 μm. The width n of the leading-end portion 243 is, for example, about several tens of nanometers to one hundred and several tens of nanometers. The width o of the flared supporting portion 245 is, for example, about 0.1 to 10 μm. The length of of the flared supporting portion 245 is, for example, 100 to 150 nm. The width p of the wide supporting portion 246 is, for example, about 5 to 10 μm. Although the width I of the magnetic-field inducing portion 241 is larger than the width p of the wide supporting portion 246 in this embodiment, the width p of the wide supporting portion 246 may be larger than the width I of the magnetic-field inducing portion 241.

The length n₁ of the bridge portion, which includes the leading-end portion 243 and the leading-end supporting portion 244, is 1 to 2 μm. The wide supporting portion 246 is an example of an “enlarged portion” in the present invention. In the subsequent process, the portion corresponding to the ferromagnetic layer 240 is polished from the supporting segment 248 side to a cross section perpendicular to the Y-axis that is taken along the line segment P-Q, thus forming the main magnetic pole segment 247, which has a predetermined throat height. The cross section perpendicular to the Y-axis that is taken along the line segment P-Q constitutes part of the floating surface of the magnetic head.

Using FIGS. 8A to 8G and 9A to 9D again, the method of this embodiment for producing the magnetic head will be described. Referring to FIG. 8C, after the ferromagnetic layer 240 is formed, a stopper layer 219a is formed so that the top surface of the ferromagnetic layer 240 can be accurately polished by chemical mechanical polishing (CMP) in the subsequent process. The stopper layer 219a is formed by a typical film-formation process such as sputtering. The stopper layer 219a may be formed of any material, for example, a material, such as tantalum, that can be polished at a lower rate than an insulating layer, such as an alumina layer, to be formed in the subsequent process.

Referring to FIG. 8D, next, a plate member having a resist pattern 220 covering the ferromagnetic layer 240 is formed. The resist pattern 220 is formed by a typical photolithography technique so as to cover a region of the ferromagnetic layer 240, the plating base layer 218a, and the stopper layer 219a that is not to be removed. The resist used may be either positive or negative. For example, a positive resist is applied to the stopper layer 219a to form a resist layer, and the resist pattern 220 is then formed by a typical photolithography technique. Specifically, for example, the resist layer is exposed with a photomask placed thereover before an exposed region of the resist layer is removed by development, thus forming the resist pattern 220. The mask is a perforated mask having an opening corresponding to the pattern of the main magnetic pole layer 211. The types of exposure equipment (exposure conditions) and developer used may be appropriately selected.

FIG. 12 is a perspective view illustrating a plate member obtained during the course of the method of the first embodiment for producing the magnetic head. This perspective view shows an example of a plate member having a resist pattern before the patterning of the plating base layer and the stopper layer. The resist pattern 220 corresponds to the shape of the ferromagnetic layer 240 and entirely covers the ferromagnetic layer 240 with a margin such that the margin around the leading-end portion 243 and the leading-end supporting portion 244 is larger than that around the magnetic-field inducing portion 241. In FIG. 12, the width k_{1R} of the resist pattern 220 near the leading-end portion 243 and the leading-end supporting portion 244 is determined so that a plating base layer having a predetermined width k₁ can be formed in an ion-milling step described below. That is, the width k_{1R} of the resist pattern 220 is determined so that a plating base layer having a width corresponding to the width I of the magnetic-field inducing portion 241 can be formed in the ion-milling step. The details will be described below.

FIG. 12 will now be used to describe the direction of an ion beam incident on the plating base layer 218a when the plating base layer 218a and the stopper layer (not shown) are etched by ion milling in the method of this embodiment for producing the magnetic head. In FIG. 12, only an insulating layer 209, the plating base layer 218a, the ferromagnetic layer 240, and the resist pattern 220 are shown, with the other layers omitted. In the ion milling, the top surface of the plate member is irradiated with an ion beam while rotating the plate member about a certain straight line along the Z-axis direction, typically at a constant angular speed. In this embodiment, the angle of incidence 0 of the ion beam is not particularly limited. A material scattered from the plating base layer 218a and the stopper layer (not shown) disposed thereon by incident ions is redeposited on the side surfaces of the resist pattern 220 used as a mask. To prevent the redeposition, the ion beam is typically made incident at an angle of incidence θ larger than 0°. As the ion beam has a larger angle of incidence θ, the redeposit is more likely to be scattered again by the ion beam and therefore to be removed from the side surfaces of the resist pattern 220. The angle of incidence θ is set to, for example, 20°.

In the ion milling of the plate member shown in FIG. 12, an ion beam Ion can be made incident on the plating base layer 218a and the stopper layer (not shown) near the resist pattern 220 for about half the irradiation time of the ion beam Ion. Specifically, the ion beam Ion can be made incident at an incidence point T₁ only within the range indicated by the arrow R. The angle of rotation α is the angle about a certain straight line along the Z-axis direction of the plate member at which the ion beam Ion can be made incident at the point T₁. Within the range indicated by the arrow S, the ion beam Ion is blocked by the resist pattern 220, thus failing to reach the point T₁. Because the angle of rotation α is about 180°, the ion beam Ion is allowed to irradiate the plating base layer 218a and the stopper layer (not shown) near the floating surface and the resist pattern 220 and the side surfaces of the resist pattern 220 near the floating surface for a relatively long period of time, thus preventing the redeposition on the side surfaces of the resist pattern 220.

After the irradiation with the ion beam Ion, the resist pattern 220 is removed, so that a plate member shown in FIG. 8F is obtained. The resist pattern 220 may be removed by any method, for example, by dipping the resist pattern 220 in a solvent that can dissolve it, or by ashing.

FIG. 13 is a perspective view illustrating a plate member obtained after the patterning of the plating base layer 218a and the stopper layer (not shown) of the plate member shown in FIG. 12. In FIG. 13, only the insulating layer 209, a plating base layer 218, and the ferromagnetic layer 240 are shown, with the other layers omitted. In the plate member shown in FIG. 13, the plating base layer 218 has a width k₁ corresponding to the width I of the magnetic-field inducing portion 241. The width k₁ and the width I is perpendicular to a direction extending from the magnetic-field inducing portion 241 to the leading-end portion 243. The corresponding width k₁ is at least larger than the width I; the difference between the widths k₁ and I is a manufacturing margin. An unnecessarily large corresponding width k₁ is not beneficial; it may pose, for example, the risk of the plating base layer 218 being electrically short-circuited to a conductive terminal (not shown) required for the operation of the magnetic head. The width I of the magnetic-field inducing portion 241 is, for example, several tens of micrometers. The difference between the widths k₁ and I is, for example, about 0.1 to 0.5 μm; it depends on the accuracy of the width of the resist pattern 220 (the width K_{1R} in FIG. 12) and is not limited to the above range. The plating base layer 218 after the patterning has an accurate edge shape. That is, the plating base layer 218 is formed through patterning by etching so that no protrusions containing the material forming the plating base layer 218 are formed in the periphery of the plating base layer 218.

The plate member having the resist pattern 220 in FIG. 8D is preferably heat-treated before the irradiation of the ion beam. The heat treatment, by which the upper corners of the resist pattern 220 are rounded, increases the proportion of the time during which the side surfaces of the resist pattern 220 are irradiated in the ion milling, thus suppressing the redeposition. The heat treatment also suppresses the redeposition by improving the adhesion between the resist pattern 220 and the stopper layer 219a formed in contact therewith; delamination of the stopper layer 219a from the resist pattern 220 would cause a problem in that redeposition would tend to occur at a site where the resist pattern 220 was delaminated from the stopper layer 219a. The heating temperature, depending on the material forming the resist pattern 220, is not particularly limited in the present invention.

The angle of incidence of the ion beam may be changed during the irradiation of the ion beam. For example, the ion milling may be carried out in two steps: a first irradiation step of irradiating the surface of the plating base layer 218a with the ion beam at an angle of incidence of 45° C. or less, primarily to remove the plating base layer 218a and the stopper layer 219a; and a second irradiation step of irradiating the surface of the plating base layer 218a with the ion beam at an angle of incidence of 45° C. or more, primarily to remove the redeposit of the materials forming the plating base layer 218a and the stopper layer 219a. The time for the second irradiation step is preferably shorter than that for the first irradiation step. This prevents the insulating layer, such as an alumina layer, provided under the plating base layer 218a from being excessively etched, thus maintain its flat surface shape. For example, the time for the second irradiation step may be set to about half the time for the first irradiation step. The ion irradiation may be terminated by determining the amount of residual film of the material forming the plating base layer 218a using an optical end-point detector or a secondary ionization mass spectrometer (SIMS).

Using FIGS. 8A to 8G and 9A to 9D again, the method of this embodiment for producing the magnetic head will be described. After the resist pattern 220 is removed, an insulating layer 221a is provided on a stopper layer 219b, so that a plate member shown in FIG. 8G is obtained. The thickness of the stopper layer 219b is typically not less than the thickness of the ferromagnetic layer 240. The insulating layer 221a is formed of, for example, a nonmagnetic, nonconductive material such as alumina. Referring to FIG. 9A, next, the top surface of the insulating layer 221a shown in FIG. 8G is subjected to first polishing by CMP until the top surface 219t of the stopper layer 219b is exposed. The first polishing is intended to lower a protrusion of the insulating layer 221a which protrudes prominently by the height of the ferromagnetic layer 240. The stopper layer 219b is then removed from the top surface of the ferromagnetic layer 240 by physical etching such as ion milling to expose the top surface 240t of the ferromagnetic layer 240, as shown in FIG. 9B. Next, the top surface 240t of the ferromagnetic layer 240 is subjected to second polishing by CMP to form a ferromagnetic layer 240b having a predetermined width (that is, the dimension of the top surface in the X-axis direction) and thickness (that is, the dimension in the Z-axis direction) required for the main magnetic pole layer 211, as shown in FIG. 9C. The second polishing is intended primarily to precisely polish the entire top surface of the main magnetic pole layer 240 and an insulating layer 221. In the second polishing, the exposed top surface of a stopper layer 219 is polished as well.

Referring to FIG. 9D, next, an insulating layer 212 and a trailing shield layer 214 are subsequently formed. In addition, a coil (not shown), a resin layer (not shown), and an insulating layer (not shown) covering the coil and the resin layer are provided on the side behind the page in FIG. 9D. Furthermore, layers (not shown) corresponding to the connecting layers 10A and 10B and the return yoke layer 15 shown in FIG. 2 are provided to magnetically connect the trailing shield layer 214 and the ferromagnetic layer 240b together. These layers can be formed using known thin-film processes, including film-formation techniques such as plating and sputtering, patterning techniques such as photolithography and etching, and polishing techniques such as machining and polishing. An overcoat layer (not shown) is then provided on the entire top surface by sputtering. Subsequently, the ferromagnetic layer 240b is polished from the supporting segment 248 side of the ferromagnetic layer 240 shown in FIG. 13 to a position corresponding to a cross section perpendicular to the Y-axis that is taken along the line segment P-Q, thus forming a main magnetic pole segment having a predetermined throat height. The magnetic head is obtained after polishing using, for example, a dicing saw, although the polishing means used is not particularly limited. Alternatively, the ferromagnetic layer 240b may be cut at a position of the supporting segment 248 corresponding to any cross section substantially parallel to the line segment P-Q in FIG. 13 before being polished from the supporting segment 248 side of the ferromagnetic layer 240 to the position corresponding to the cross section perpendicular to the Y-axis that is taken along the line segment P-Q.

Although the stopper layers 219, 219a, and 219b are provided to facilitate the formation of the main magnetic pole layer 11 in a desired shape by CMP in the above production process, the insulating layer 221a and the ferromagnetic layer 240 may be polished with no stopper layer provided on the ferromagnetic layer 240 and the plating base layer 218 in the method for producing the magnetic head of the present invention. In addition, the polishing method is not limited to CMR

Next, a second embodiment of the method for producing the magnetic head will be described. In the description of the second embodiment, the details overlapping those described in the first embodiment will be skipped.

First, as in the first embodiment, an insulating layer of a material such as alumina, a plating base layer, a ferromagnetic layer, and a stopper layer are formed on a substrate of a material such as AlTiC.

Next, a plate member having a resist pattern covering the ferromagnetic layer is formed. The means for forming the resist pattern is similar to that of the first embodiment, although its shape differs from that of the first embodiment.

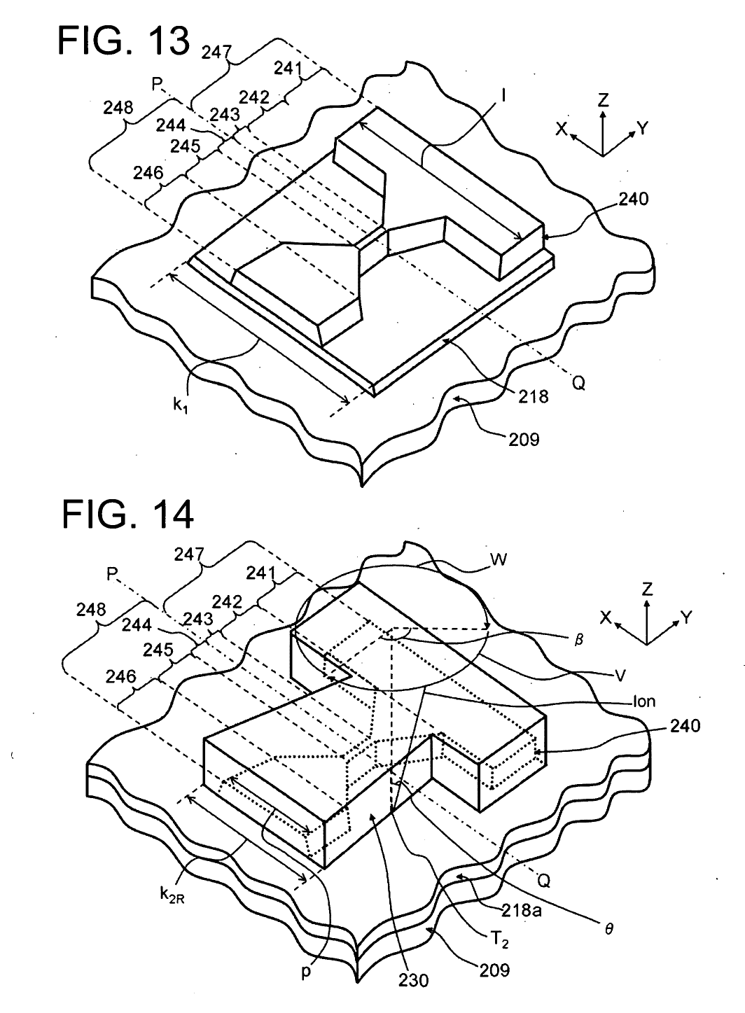

FIG. 14 is a perspective view illustrating a plate member obtained during the course of the method of the second embodiment for producing the magnetic head. Instead of the resist pattern 220 of the plate member shown in FIG. 12, the plate member shown in FIG. 14 has a resist pattern 230 that differs in shape from the resist pattern 220 before the patterning of the plating base layer and the stopper layer. In FIG. 14, the width k_{2R} of the resist pattern 230 near the leading-end portion 243 and the leading-end supporting portion 244 corresponds to the width p of the wide supporting portion 246. In FIG. 14, the width k_{2R} of the resist pattern 230 near the leading-end portion 243 and the leading-end supporting portion 244 is determined so that a plating base layer having a width corresponding to the width p of the wide supporting portion 246 can be formed in a subsequent ion-milling step.

After the resist pattern 230 is formed, the plating base layer 218a and the stopper layer 219a are patterned by physical etching such as ion milling to form the plating base layer 218 and the stopper layer 219b.

FIG. 14 will now be used to describe the direction of an ion beam incident on the plating base layer 218a when the plating base layer 218a and the stopper layer (not shown) are etched by ion milling in the method of the second embodiment for producing the magnetic head. In FIG. 14, only the insulating layer 209, the plating base layer 218a, the ferromagnetic layer 240, and the resist pattern 230 are shown, with the other layers omitted. In the ion milling of the plate member shown in FIG. 14, as is the case of the plate member shown in FIG. 12, the ion beam Ion can be made incident on the plating base layer 218a and the stopper layer (not shown) near the floating surface and the resist pattern 230 (for example, at a point T₂) and the side surfaces of the resist pattern 230 near the floating surface for a relatively long period of time. Specifically, the ion beam Ion can be made incident at the incidence point T₂ only within the range indicated by the arrow V. The angle of rotation β is the angle about a certain straight line along the Z-axis direction of the plate member at which the ion beam Ion can be made incident at the point T₂. Within the range indicated by the arrow W, the ion beam Ion is blocked by the resist pattern 230, thus failing to reach the point T₂. The angle of rotation β is about 90° to 180°, depending on the angle of incidence θ of the ion beam Ion and the shape of the resist pattern 230. The ion beam Ion is allowed to irradiate the point T₂ near the floating surface and the side surfaces of the resist pattern 230 for a relatively long period of time.

After the irradiation with the ion beam Ion, the resist pattern 230 is removed as in the first embodiment.

FIG. 15 is a perspective view illustrating a plate member obtained after the patterning of the plating base layer 218a and the stopper layer (not shown) of the plate member shown in FIG. 14. In FIG. 15, only the insulating layer 209, the plating base layer 218, and the ferromagnetic layer 240 are shown, with the other layers omitted.

In the plate member shown in FIG. 15, the plating base layer 218 has a width k₂ corresponding to the width p of the wide supporting portion 246 of the supporting segment 248. In other words, the width k₂ of the plating base layer 218 in parts of the plating base layer 218 having a margin extending outwardly from the periphery of the leading-end portion 243 and leading-end supporting portion 244 corresponds to the width p of the wide supporting portion 246. The corresponding width k₂ is at least larger than the width p; the difference between the widths k₂ and p is a manufacturing margin. An unnecessarily large corresponding width k₂ is not beneficial; it may pose, for example, the risk of the plating base layer 218 being electrically short-circuited to a conductive terminal (not shown) required for the operation of the magnetic head. The width p of the wide supporting portion 246 is, for example, about 5 to 10 μm. The difference between the widths k₂ and p is, for example, about 0.1 to 0.5 μm; it depends on the accuracy of the width of the resist pattern 230 (the width K_{2R} in FIG. 14).

The process after the removal of the resist pattern 230 is similar to that of the first embodiment; a description thereof will be omitted. In the magnetic head produced by the method illustrated in the second embodiment, the plating base layer 218 has an accurate edge shape. That is, the plating base layer 218 is formed through patterning by etching so that no protrusions containing the material forming the plating base layer 218 are formed in the periphery of the plating base layer 218.

As described in the first and second embodiments, the resist pattern has a width corresponding to the width of the enlarged portion. If a plurality of enlarged portions are present, the width of the resist pattern must be larger than the width of the narrowest one of the enlarged portions. The first embodiment is preferable to the second embodiment in that redeposition can be more effectively prevented because an ion beam is allowed to irradiate the plating base layer and the stopper layer near the floating surface and the resist pattern and the side surfaces of the resist pattern near the floating surface for a longer period of time.

If the width of the enlarged portion is not constant, the resist pattern has a width corresponding to the maximum width of the enlarged portion. In addition, if a plurality of enlarged portions are present and their widths are not constant, the width of the resist pattern must be larger than the minimum one of the maximum widths of the individual enlarged portions.

Next, a method for producing a magnetic head of a comparative example will be described. In the description of the comparative example, the details overlapping those described in the first embodiment will be skipped.

First, as in the first embodiment, an insulating layer of a material such as alumina, a plating base layer, a ferromagnetic layer, and a stopper layer are formed on a substrate of a material such as AlTiC.

Next, a plate member having a resist pattern covering the ferromagnetic layer is formed. The means for forming the resist pattern is similar to that of the first embodiment, although its shape differs from that of the first embodiment.

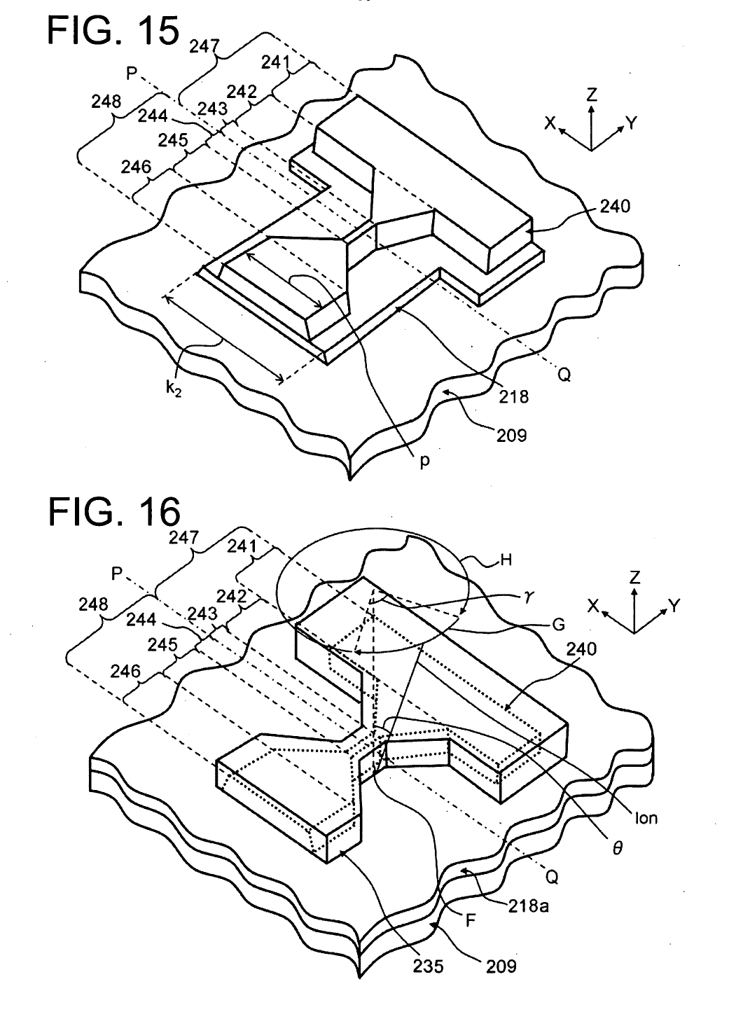

FIG. 16 is a perspective view illustrating a plate member obtained during the production of the magnetic head of the comparative example. This perspective view shows a plate member before the patterning of the plating base layer and the stopper layer. In FIG. 16, only the insulating layer 209, the plating base layer 218a, the ferromagnetic layer 240, and a resist pattern 235 are shown, with the other layers omitted. The configuration of the other layers, the shapes and materials of the individual layers, and the methods for forming them are similar to those of the above embodiments. In addition, the shapes and materials of the insulating layer 209, the plating base layer 218a, and the ferromagnetic layer 240 and the methods for forming them are similar to those of the first embodiment. The material of the resist pattern 235 and the method for forming it are similar to those of the resist pattern 220 in the first embodiment. The resist pattern 235 shown in FIG. 16 includes a portion whose width corresponds to the width n of the leading-end portion 243 and the leading-end supporting portion 244.

After the resist pattern 235 is formed, the plating base layer 218a and the stopper layer 219a are patterned by physical etching such as ion milling to form the plating base layer 218 and the stopper layer 219b.

FIG. 16 will now be used to describe the direction of an ion beam incident on the plating base layer 218a when the plating base layer 218a and the stopper layer (not shown) are etched by ion milling in the method for producing the magnetic head of the comparative example. In the ion milling of the plate member shown in FIG. 16, the ion beam Ion can be made incident on the plating base layer 218a and the stopper layer (not shown) near the resist pattern 235 for about ⅙ the irradiation time of the ion beam Ion. Specifically, the ion beam Ion can be made incident at an incidence point F only within the range indicated by the arrow G. The angle of rotation γ is the angle about a certain straight line along the Z-axis direction of the plate member at which the ion beam Ion can be made incident at the point F. Within the range indicated by the arrow H, the ion beam Ion is blocked by the resist pattern 235, thus failing to reach the point F. The angle of rotation γ is about 60° near the point F, which is not irradiated with the ion beam Ion for as long a period of time as the points T₁ and T₂ in the above embodiments. Thus, redeposition may occur near the point F.

After the irradiation with the ion beam Ion, the resist pattern 235 is removed as in the first embodiment.

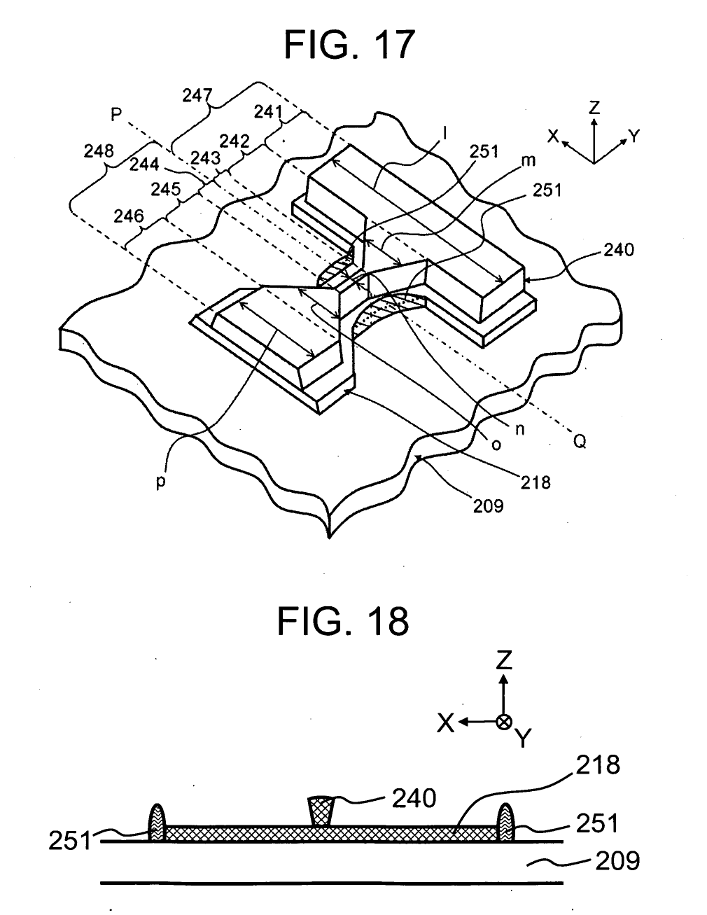

FIG. 17 is a perspective view illustrating a plate member obtained during the production of the magnetic head of the comparative example. This perspective view shows a plate member obtained after the patterning of the plating base layer 218a and the stopper layer (not shown) of the plate member shown in FIG. 16. In FIG. 17, only the insulating layer 209, the plating base layer 218, and the ferromagnetic layer 240 are shown, with the other layers omitted. The configuration of the other layers, the shapes and materials of the individual layers, and the methods for forming them are similar to those of the above embodiments. In addition, the materials of the insulating layer 209, the plating base layer 218a, and the ferromagnetic layer 240 and the methods for forming them are similar to those of the above embodiments. The material of the resist pattern 235 and the method for forming it are similar to those of the resist pattern 220 in the first embodiment. FIG. 18 is a sectional view illustrating a cross section of the plate member shown in FIG. 17 perpendicular to the Y-axis that is taken along the line segment P-Q.

The plating base layer 218 of the magnetic head of the comparative example includes a plurality of portions whose widths correspond to the widths I, m, and n of the magnetic-field inducing portion 241, the flared portion 242, and the leading-end portion 243, which constitute the main magnetic pole segment 247, and the widths n, o, and p of the leading-end supporting portion 244, the flared supporting portion 245, and the wide supporting portion 246, which constitute the supporting segment 248. The comparative example differs from the above embodiments in that the plating base layer 218 includes the portions whose widths correspond to the widths m, n, n, and o of the flared portion 242, the leading-end portion 243, the leading-end supporting portion 244, and the flared supporting portion 245. Redeposits 251 are formed on the edges of the plating base layer 218 near the above portions because these portions are insufficiently irradiated with the ion beam during the ion milling.

When an insulating layer and a trailing shield layer are formed on the redeposits 251, these layers are raised along the shapes of the redeposits 251. This results in failure to form the layers in desired shapes, defects or voids in the layers, and deviations from their desired compositions. The magnetic head in which the insulating layer and the trailing shield layer are not formed in desired shapes may have poor recording performance. In addition, in the magnetic head in which the insulating layer and the trailing shield layer include portions with defects, voids, or deviations from their desired compositions on the floating surface side, these portions may trap cuttings from the floating surface side, slurry, and platen material in the step of lapping or polishing the floating surface side. The portions with defects, voids, or deviations from the desired compositions and the trapped cuttings, for example, may come off inside the magnetic disk apparatus, thus leaving contaminants. Such contaminants may cause a serious malfunction in the recording and playback of information in the magnetic disk apparatus.

The process after the removal of the resist pattern 235 is similar to that of the first embodiment; a description thereof will be omitted.

In the method for producing a magnetic head according to the above embodiments, the material forming the plating base layer is less likely to be deposited along the pattern of the plating base layer around the narrowed portion of the magnetic layer, so that a magnetic head of desired shape and composition can be produced. In addition, a magnetic disk apparatus including the magnetic head thus produced is highly reliable because its information recording/playback performance is maintained.

The present invention is not limited to the above embodiments, which are merely illustrative. The technical scope of the present invention encompasses any embodiment that has substantially the same configuration as the technical idea set forth in the claims of the present invention and that provides similar effects and advantages.

What is claimed is:

1. A method for producing a magnetic head comprising:
forming a plating base layer on a substrate;
forming a magnetic layer including an enlarged portion and a narrowed portion extending therefrom on the plating base layer by plating;
forming a resist pattern on the magnetic layer and the plating base layer, the resist pattern corresponding to the shape of the magnetic layer and entirely covering the magnetic layer with a margin such that the margin around the narrowed portion is larger than that around the enlarged portion;
patterning the plating base layer by etching with the resist pattern used as a mask;
forming an insulating layer over the magnetic layer and the plating base layer; and
forming an auxiliary magnetic layer on the insulating layer so that the auxiliary magnetic layer is magnetically connected to the magnetic layer.

2. The method according to claim 1, wherein the enlarged portion includes a first enlarged portion and a second enlarged portion with the narrowed portion disposed therebetween, the method further comprising:
removing the second enlarged portion after forming the auxiliary magnetic layer; and
polishing an end of the narrowed portion.

3. The method according to claim 2, wherein the resist pattern is wider than the narrower one of the first and second enlarged portions.

4. The method according to claim 1, wherein the resist pattern is wider than the enlarged portion so as to correspond to the shape of the enlarged portion in forming the resist pattern.

5. The method according to claim 1, further comprising heating the resist pattern before patterning the plating base layer.

6. The method according to claim 1, wherein patterning the plating base layer includes irradiating a surface of the plating base layer with an ion beam at an angle of incidence of 45° or less.

7. The method according to claim 1, wherein patterning the plating base layer includes terminating the irradiation with the ion beam by determining the amount of material forming the plating base layer.

8. The method according to claim 1, wherein patterning the plating base layer includes irradiating a surface of the plating base layer with an ion beam at an angle of incidence of 45° or less and irradiating the surface of the plating base layer with the ion beam at an angle of incidence of 45° or more.

9. The method according to claim 8, wherein the time for irradiating at the angle of incidence of 45° or more is shorter than the time for irradiating at the angle of incidence of 45° or less.

10. The method according to claim 1, further comprising forming a stopper layer for use in processing the shape of the magnetic layer on the magnetic layer after forming the magnetic layer, the stopper layer being patterned in patterning the plating base layer.

11. A magnetic head comprising:
a substrate;
a plating base layer disposed on the substrate;
a magnetic layer including an enlarged portion and a narrowed portion extending therefrom, the shape of the magnetic layer corresponding to that of the plating base layer, the magnetic layer being partly disposed on the plating base layer such that the plating base layer have a margin extending outwardly from the periphery of the magnetic layer, the margin around the narrowed portion being larger than that around the enlarged portion;
an insulating layer disposed over the magnetic layer; and
an auxiliary magnetic layer disposed on the insulating layer and magnetically connected to the magnetic layer.

12. The magnetic head according to claim 11, wherein the margin of the plating base layer has a straight edge so as to prevent deposition of the material of the plating base layer around the narrowed portion which would otherwise occur during etching of the plating base layer.

13. The magnetic head according to claim 11, wherein the plating base layer includes an enlarged portion and a narrowed portion extending therefrom.

14. The magnetic head according to claim 11, wherein the plating base layer has a larger width than the enlarged portion, the width being substantially perpendicular to a direction from the enlarged portion to the narrowed portion.
